(19) United States
(12) Patent Application Publication
(10) Pub. No.: US 2024/0283611 A1
(43) Pub. Date: Aug. 22, 2024

(54) QUANTIZATION FOR ARTIFICIAL INTELLIGENCE BASED CSI FEEDBACK COMPRESSION

(71) Applicant: Apple Inc., Cupertino, CA (US)

(72) Inventors: Huaning Niu, San Jose, CA (US); Weidong Yang, San Diego, CA (US); Parvathanathan Subrahmanya, Sunnyvale, CA (US); Dawei Zhang, Saratoga, CA (US)

(21) Appl. No.: 18/425,568

(22) Filed: Jan. 29, 2024

Related U.S. Application Data
(60) Provisional application No. 63/485,595, filed on Feb. 17, 2023.

(51) Int. Cl. H04L 5/00; H04W 72/21

(52) U.S. Cl. CPC H04L 5/0053; H04W 72/21

(57) ABSTRACT

Systems, methods, and circuitries are provided for quantizing artificial intelligence (AI)-based compressed channel state information (CSI) feedback. In one example, a method includes receiving a set of encoder outputs from an AI-based encoder that generates compressed CSI feedback. The method includes optimizing a per-segment vector quantization (VQ) codebook for use in quantizing respective segments of encoder outputs based on the set of encoder outputs. A number of inputs of the VQ codebook and a number of outputs of the VQ codebook are based on a number of bits configured for uplink channel information (UCI) and a number of segments.

### REFERENCE TO RELATED APPLICATIONS

This application claims the benefit of U.S. Provisional Application No. 63/485,595, filed on Feb. 17, 2023, the contents of which are hereby incorporated by reference in their entirety

### BACKGROUND

The present disclosure relates generally to wireless communication and more specifically to techniques for communicating channel status information to a radio access network (RAN) node.

### BRIEF DESCRIPTION OF THE DRAWINGS

Some examples of circuits, apparatuses and/or methods will be described in the following by way of example only. In this context, reference will be made to the accompanying figures.

FIG. 1 is a diagram of an example an artificial intelligence (AI)-based CSI compression system, in accordance with various aspects described.

FIG. 2 is a diagram of an example neural network (NN), in accordance with various aspects described.

FIGS. 3A, 3B, 3C are functional diagrams of respective training techniques for training an encoder and decoder for AI-based CSI feedback compression, in accordance with various aspects described.

FIG. 4 is a flow diagram outlining a segmentation based vector quantization (VQ) codebook training process, in accordance with various aspects described.

FIG. 5 is a flow diagram outlining a segmentation based vector quantization (VQ) codebook quantization/de-quantization process, in accordance with various aspects described.

FIG. 6 is a flow diagram outlining an example method for optimizing a VQ codebook, in accordance with various aspects described.

FIGS. 6A, 6B, 6C, 6D illustrate exemplary an example transfer process for an optimized VQ codebook with the different NN training techniques of FIGS. 3A, 3B, 3C.

FIG. 7 is a flow diagram outlining an example method for optimizing a VQ codebook, in accordance with various aspects described.

FIGS. 7A, 7B, 7C, 7D illustrate an example transfer process for an optimized VQ codebook with the different NN training techniques of FIGS. 3A, 3B, 3C.

FIG. 8 is a flow diagram outlining an example method for optimizing a VQ codebook, in accordance with various aspects described.

FIGS. 8A, 8B, 8C, 8D illustrate an example transfer process for an optimized VQ codebook with the different NN training techniques of FIGS. 3A, 3B, 3C.

FIG. 9 is a flow diagram outlining an example method for optimizing a vector quantization codebook, in accordance with various aspects described.

FIG. 10 is a flow diagram outlining an example method for scalar quantization of encoder outputs, in accordance with various aspects described.

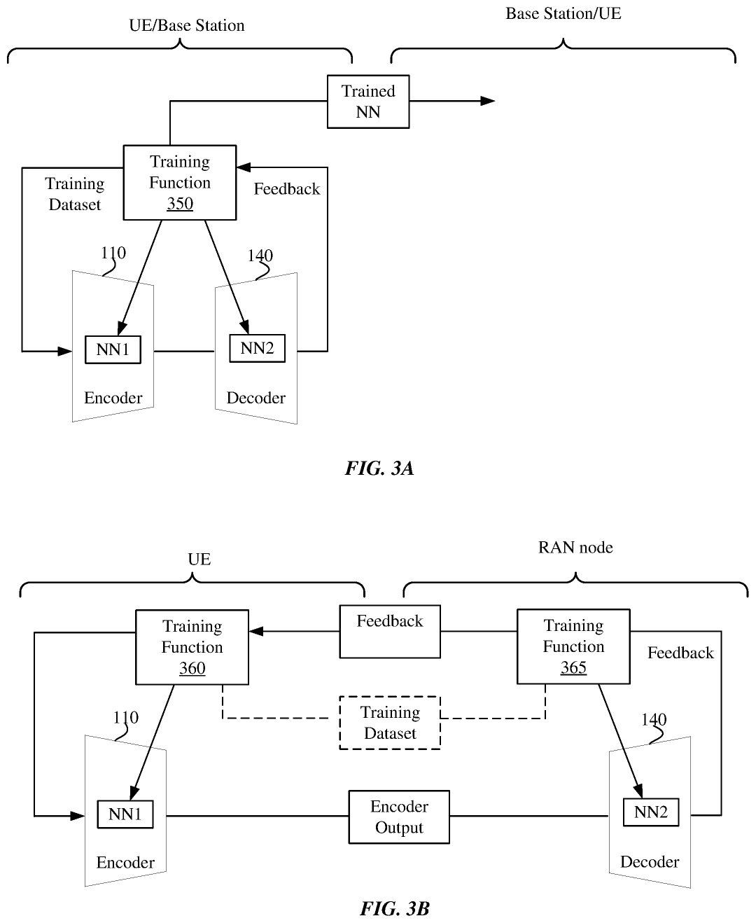

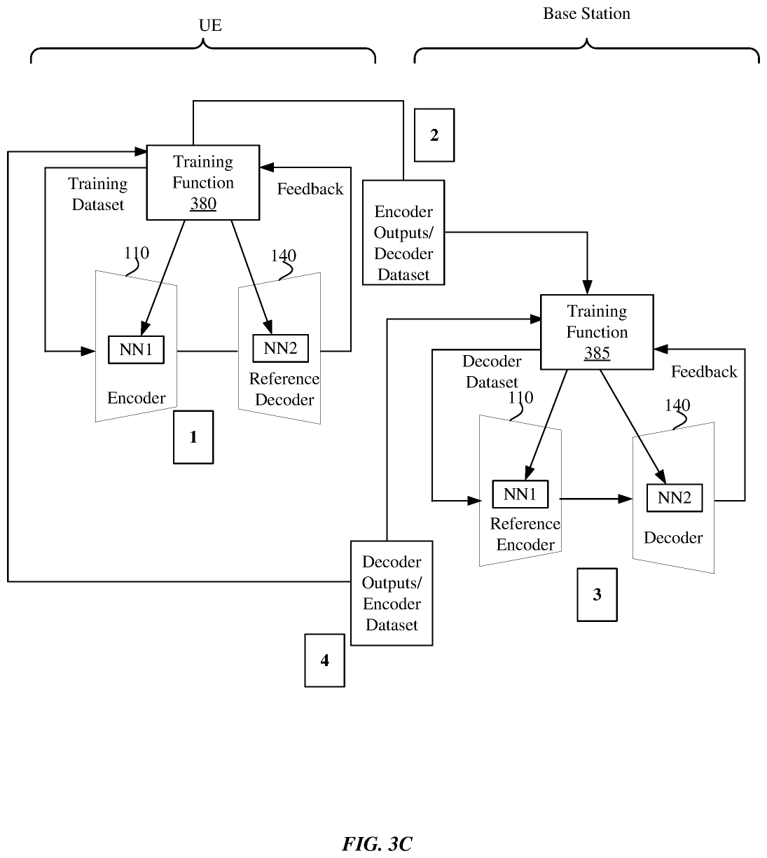

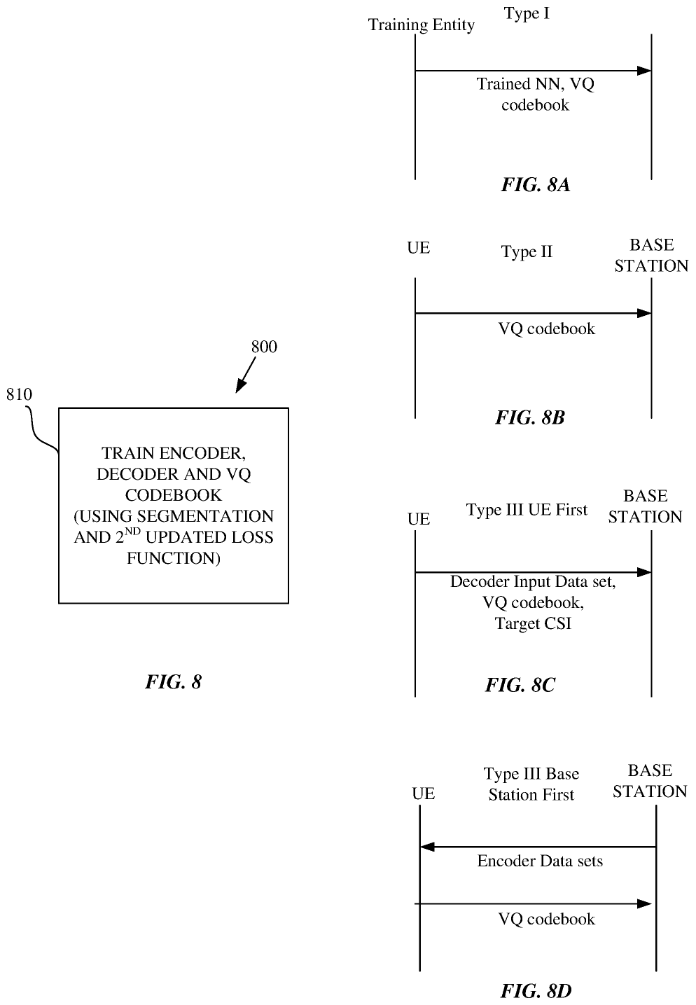

FIGS. 8A, 8B, 8C, 8D illustrate an example transfer process for scalar quantizer with the different NN training techniques of FIGS. 3A, 3B, 3C.

FIG. 11 is a functional block diagram of a wireless communication network, in accordance with various aspects described.

FIG. 12 illustrates a simplified block diagram of a network device, in accordance with various aspects described.

### DETAILED DESCRIPTION

The present disclosure is described with reference to the attached figures. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

In massive multiple-input multiple-output (MIMO) communication systems, base stations are equipped with a large number of active antennas and are simultaneously serving multiple users. Knowledge of accurate channel state information (CSI) at the base station is important to maximizing performance gains achievable through MIMO. Base station is used herein as a shorthand for referring to any type of RAN node including base stations (eNB, gNB, and so on), transmission/reception points (TRPs), and so on. Downlink CSI acquisition includes two main steps. First the user (e.g., user equipment (UE)) estimates a downlink (DL) CSI utilizing received reference signals from the base station. Then the user feeds an estimated DL CSI back to the base station through the uplink (UL) control channel (e.g., physical uplink control channel (PUCCH)). In massive MIMO systems, a large number of antennas at the base station result in a wide CSI dimension, resulting in substantial feedback overhead. Considerable performance loss is experienced when the base station transmits to a user based on outdated CSI information. Thus, a main objective of CSI feedback is reduced overhead with improved accuracy even as the number of possible channels increases exponentially due to massive MIMO.

Conventional CSI methods utilize a codebook-based approach in which a user and the base station share a codebook comprising a set of precoding matrices, or codewords, which are each mapped to a unique index. The user selects a codeword based on the estimated DL CSI and transmits the index for the codeword to the base station. The base station accesses its copy of the codebook to determine the precoding matrix mapped to the received codeword. While effective, codebook-based CSI feedback has some shortcomings. Feedback accuracy is improved with larger codebooks. For example, the TYPE II codebook in 5G New Radio (NR) outperforms the smaller TYPE I codebook, but at the expense of a substantial increase in feedback bit number. In addition, the codeword search complexity significantly increases with codebook size.

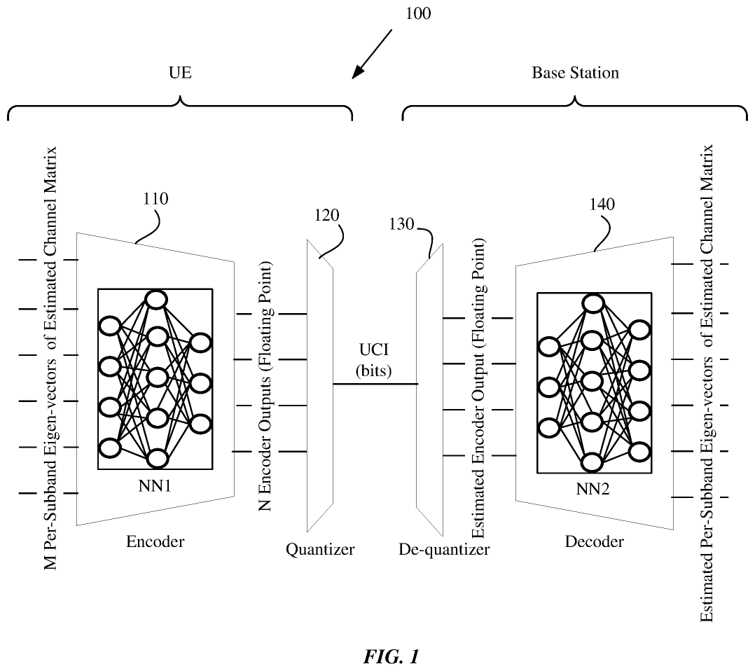

Artificial intelligence (AI)-based CSI compression is under consideration for improving CSI feedback in massive MIMO systems. In AI-based CSI feedback, a neural network (NN) in the UE and base station learns to automate compression and reconstruction of CSI without reliance on a shared codebook. FIG. 1 illustrates an AI-based CSI feedback compression system 100 in which UE side AI model equipped encoder circuitry 110 and base station side decoder circuitry 140 each include a NN (NN1 for the UE and NN2 for the base station) associated with a two-sided AI model used for CSI feedback compression. The encoder 110 (sometimes referred to as an auto-encoder) inputs M eigen-vectors, each corresponding to one of M subbands of the estimated channel matrix, and generates, using the NN1, N encoder outputs. The encoder outputs may be floating point numbers.

Quantizer circuitry 120 quantizes respective encoder outputs using respective numbers of bits. The resulting bits are communicated as uplink channel information (UCI) to the base station. On the base station side, the received UCI is de-quantized by de-quantizer circuitry 130 to generate an estimated encoder output. The de-quantizer circuitry 130 has knowledge (e.g., via a shared vector quantization (VQ) codebook) of the quantization method used by the quantizer circuitry 120. Decoder circuitry 140 inputs the estimated encoder output to the NN to re-construct the CSI feedback (e.g., channel matrix). The base station uses the re-constructed channel matrix to control various DL transmission parameters such as, for example, precoder settings.

### Neural Network Overview

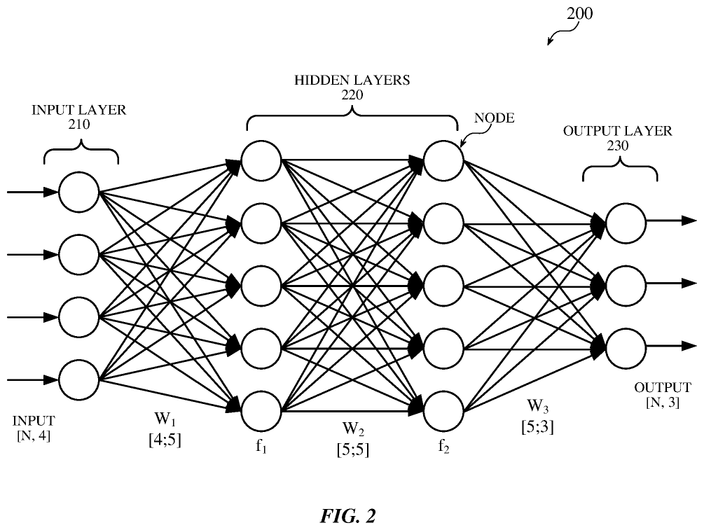

The encoding and decoding functions performed by the two sided AI model are performed by neural networks. FIG. 2 is a diagram of an example of a neural network (NN) 200 according to one or more implementations described herein. As shown, NN 200 may include nodes arranged in different layers, such as an input layer 210 of nodes, multiple hidden or intermediary layers 220 of nodes, and an output layer 230 of nodes.

Example NN 200 may include a number N of inputs introduced to four input nodes [N, 4] of input layer 310. This may include processing or encoding input data into a form, shape, vector, or data structure, that is receivable by the NN. The four input nodes may process the inputs to produce a first weight (W₁) that the four input nodes provide to the five nodes [4;5] of a first hidden layer. The five nodes of the first hidden layer may use a first function (f₁) to process the inputs to produce a second weight (W₂) that the five nodes of the first hidden layer may provide to the five nodes [5;5] of a second hidden layer. The five nodes of the second layer may use a second function (f₂) to process the inputs to produce a third weight (W₃) that the five nodes of the second hidden layer may provide to the three nodes [5;3] of output layer 230. The nodes of output layer 230 may each process the inputs received and produce an output. This may include converting or decoding output data from a form, shape, vector, or data structure, that may be used by a subsequent algorithm, process, or procedure.

### Neural Network Training Overview

FIGS. 3A-3C illustrate several possible training scenarios for training the neural networks in the encoder 110 and decoder 140. According to the two-sided model, NN1 in the encoder 110 maps the CSI matrix to a low-dimensional compressed space, while NN2 in the decoder 140 maps the received feedback information to the original dimension to construct an approximation of the CSI matrix. In some aspects NN1 is referred to as the auto-encoder of a two-sided auto-encoder framework and NN2 is referred to as the auto-decoder of the two-sided auto-encoder framework. The training data set may be a set of CSI matrices that is representative of one or more potential dimensions between the UE and the base station. It is understood that training functions in devices performing training have knowledge of a shared training data set.

NN1 and NN2 may be jointly trained or separately trained. Joint training means that that NN1 and NN2 are both included in the training loop and trained simultaneously. In other words, during training of both the encoder and the decoder, the output of NN1 is coupled (directly or over-the-air) to the input of NN2 during training. FIG. 3A illustrates joint training performed by a single entity/side (i.e., UE side or base station side). In this example, after training of both NN1 and NN2 by the training entity, one of the trained neural networks is transmitted to the side that did not perform the training. For example, training function circuitry 350 in the base station may train both NN1 and NN2 and then transmit the trained NN1 to the UE. This approach reduces the required complexity of the UE, but incurs the overhead of transmitting the trained NN1.

FIG. 3B illustrates a scenario in which joint training of NN1 and NN2 is performed by a training function circuitry 360 in the UE, which trains NN1, and a training function circuitry 365 in the base station, which trains NN2, in the same training loop. In this scheme, a trained NN does not need to be transmitted between entities, however the encoder output and feedback (decoder output) are transmitted over-the-are between the UE and the base station.

FIG. 3C illustrates separate training of one of the NNs by one entity followed by training of the other NN by the other entity. FIG. 3C illustrates the case in which the UE starts the separate training process. The case in which the base station starts the process is analogous. At 1, training function circuitry 380 in the UE trains NN1 using a reference version of the NN2 model. At 2, the UE transmits the trained encoder inputs (target CSI) and outputs as a decoder data set to the base station. At 3, training function circuitry 385 in the base station trains NN2 using the decoder data set. It should be noted that the NN2 model trained at 3 is designed by the network and can be different from the reference NN2 model used by the UE at 1. Further, when the base station starts the training process, a reference NN1 model the base station uses at 1 may be different from the NN1 model trained by the UE at 3. At 4, the base station transmits the trained decoder inputs and outputs as an encoder data set to the UE for further training of NN1. Steps 1 and 3 may be performed repeatedly, and/or sequentially (as described) or in parallel.

### Quantization

Since the CSI report (e.g., UCI) is transmitted in the form of a bitstream, quantizer circuitry is used to discretize the codeword transmitted in codeword-based CSI feedback systems. As most codeword values are expected to be zero or near zero, in the TYPE II codebook, a non-uniform quantization technique is used in which only the strongest values are communicated, with more bits used to represent the very strongest value.

Returning to FIG. 1, in AI-based CSI feedback compression, the overhead associated with transmitting the floating point encoder outputs in a bitstream would be very large. To address this issue, the quantizer 120 discretizes the encoder outputs into a desired number of UCI bits. This quantization is an important part of the AI-based CSI feedback compression process as quantization errors may significantly degrade the performance of the system. There are two types of quantization-vector quantization and scalar quantization. In vector quantization, groups of input values are quantized, while in scalar quantization, each value is quantized separately. Vector quantization produces a more accurate quantization but at the expense of increased computational complexity. Thus, both types of quantization should be considered for the AI-based CSI feedback compression system.

A shared quantization codebook may be used by the quantizer circuitry 120 and the de-quantizer circuitry 130. The codebook should be optimized based on the expected output of the encoder 110 and the quantization of the output by the quantizer circuitry 120 will have an effect on the end-to-end performance of the AI-based CSI feedback compression system. Thus, it may be beneficial to include optimization of the codebook with the training process. However, the extent to which the optimization of the codebook is involved with the end-to-end training of the two-sided model will come with performance and scalability trade-offs.

### Vector Quantization (VQ) Codebook Optimization

A VQ codebook may be optimized based on trained encoder outputs, which may be floating point values. The dimension of the encoder output impacts the size of the VQ codebook. According to the training techniques of FIGS. 3A-3C, during or after training, the VQ codebook may need to be transmitted from an entity (e.g., the UE or base station) that optimizes the VQ codebook to the other entity after the optimization is complete. As the encoder output size increases, the overhead associated with transmitting the VQ codebook may become overly burdensome.

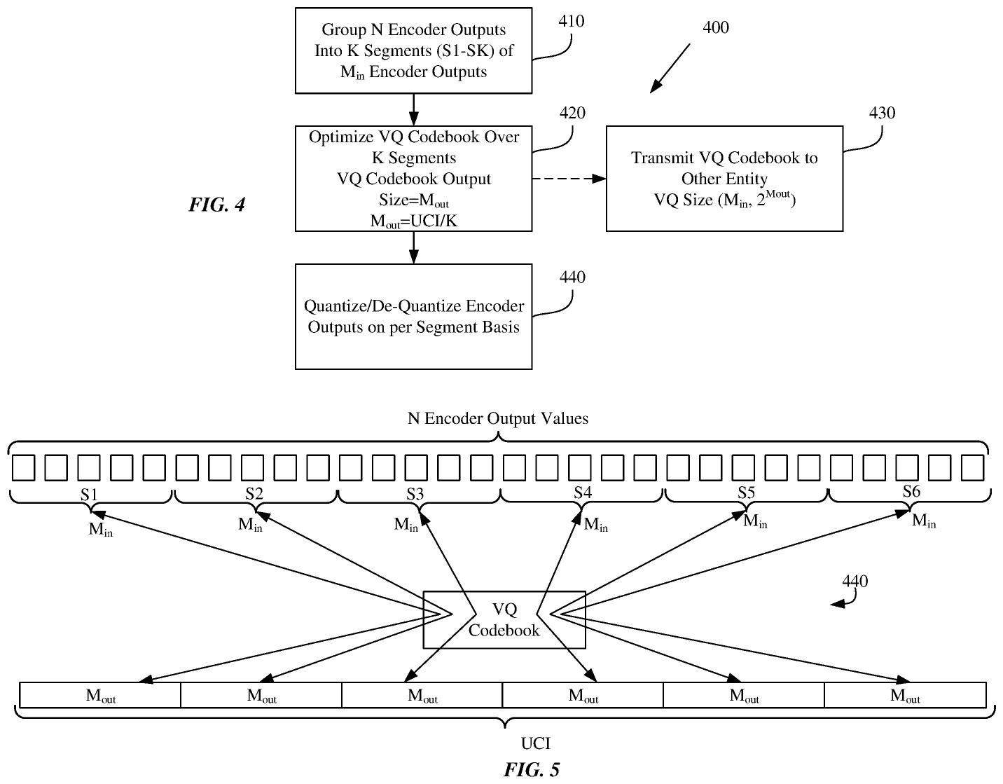

FIG. 4 illustrates an example segment-based codebook optimization method 400 that may be used to reduce the size of the VQ codebook. At 410, N encoder output values are grouped into K segments, resulting in K sets of adjacent encoder output values. The number of encoder values in each segment is the input size of the VQ codebook, Mᵢₙ. An output size of the codebook, Mₒᵤₜ, (e.g., a bitwidth) is determined based on a desired UCI size (e.g., UCI size/K). Values for Mᵢₙ, Mₒᵤₜ, K, N, and/or UCI size may be set by 3GPP specification or configured via higher layer signaling to facilitate the VQ codebook optimization process. At 420 a VQ codebook having the input size Mᵢₙ and the output size Mₒᵤₜ is optimized over all the K segments. At 430, the resulting optimized VQ codebook may be transmitted to another entity (e.g., from a base station to a UE) that is participating in AI based CSI feedback compression with the VQ codebook optimizing entity. At 440, the optimized VQ codebook is used to quantize subsequently generated encoder outputs and de-quantize UCI bits during subsequent CSI feedback compression, an example of which is illustrated in FIG. 5.

In FIG. 5, the number of encoder outputs N is 30, the number of segments K is 6, the UCI bitwidth is 60, Mᵢₙ is 5, and Mₒᵤₜ is 10. At the encoder side, the quantization moves from top to bottom in FIG. 5. The N encoder outputs are grouped into K segments (S1-S6) of Mᵢₙ values and, in succession, the values in each encoder output segment are quantized using the VQ codebook into K UCI segments, each having Mₒᵤₜ bits. The UCI segments are combined to generate a bitstream of the desired number of UCI bits. At the decoder side, the quantization moves from the bottom to the top of FIG. 5 and the UCI is segmented into K segments of Mₒᵤₜ bits. Each segment is de-quantized using the VQ codebook to generate a corresponding estimated encoder output segment, which is a set of Mᵢₙ estimated encoder output values. The estimated encoder output segments are combined to re-construct the set of N encoder outputs. It can be seen that by using the segmentation method, the VQ codebook dimension that is related to the number of values in a segment rather than the total number of encoder output values, greatly enhancing the scalability of the VQ codebook and reducing the overhead associated with transmitting the VQ codebook.

In one example, the VQ codebook is specified by standard to enable multi-vendor operability. In other examples, disclosed herein, the segmentation method disclosed above is used to optimize a VQ codebook for use with AI-based CSI feedback compression encoders and decoders.

### Quantization Non-Aware VQ Codebook Optimization

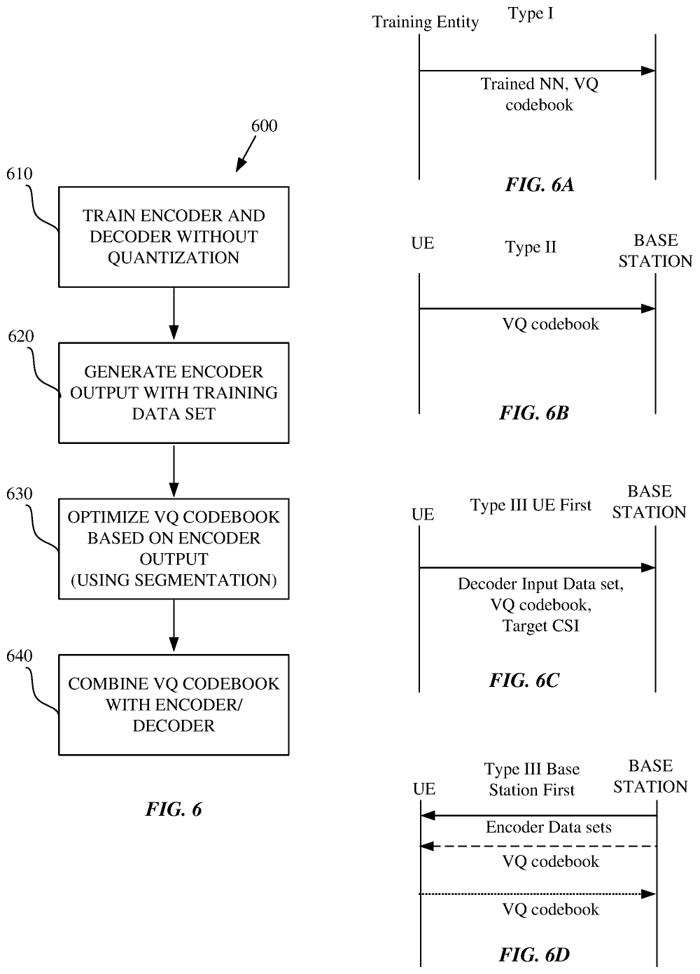

FIG. 6 is a flow diagram outlining an example method 600 for optimizing a VQ codebook in which the training of the encoder and decoder does not take into account the quantization aspect. At 610, the encoder and decoder are trained without quantization using a training data set. This step may be facilitated by limiting a range of encoder output values for easier quantization. In one example, the encoder output is limited to a value between 0 and 1, which may be implemented by including a sigmod activation function as the last layer of the NN1 and NN2. At 620, inferencing is run on the training data set with the trained encoder to generate a VQ codebook training data set. At 630, the VQ codebook is optimized using the segment-based technique based on the VQ codebook training data set. For example, the VQ codebook may be optimized using Linde-Buzo-Gray (LBG) based algorithm or other appropriate algorithm.

At 640, the optimized VQ codebook is combined with the encoder and decoder for end-to-end inferencing for CSI feedback compression. Combining the VQ codebook with the encoder and decoder includes transmitting the optimized VQ codebook to the non-optimizing entity using physical uplink shared channel (PUSCH) or physical downlink shared channel (PDSCH). As disclosed with reference to FIGS. 4 and 5, a segment-based VQ codebook will be a matrix having the dimension Mⁱⁿ, 2^{Mout}, where Mᵢₙ is the number of encoder output values per segment and Mₒᵤₜ is the number of VQ output bits per segment. FIG. 6A illustrates how operation 640 is performed during type I joint training (see FIG. 3A). The training entity (e.g., either UE or base station) performs steps 610-630 and then transmits the optimized VQ codebook along with the trained NN (e.g., a set of weights) to the non-training entity. FIG. 6B illustrates how operation 640 is performed during type II joint training (see FIG. 3B). The encoder and decoder are trained jointly at 610, and then the UE performs steps 620-630 and transmits the optimized VQ codebook to the base station.

FIG. 6C illustrates how operation 640 is performed during type III separate training (see FIG. 3C). In type Ill training, when the UE trains its encoder using the reference decoder, the UE optimizes the VQ codebook using trained encoder outputs generated based on the training data set and then transmits the VQ codebook and the encoder outputs (the decoder input data set before de-quantization) as well as the target CSI feedback (the optimal decoder output) the to the base station.

FIG. 6D illustrates how operation 640 is performed during type III training when the base station trains first. In one example, the base station optimizes the VQ codebook. The base station trains the decoder using the base station's reference encoder, then the base station optimizes the VQ codebook using the reference encoder output data set. The base station then transmits the optimized VQ codebook (shown in dashed line), the trained reference encoder outputs and the encoder input data (the encoder data sets) to the UE for use in performing 610-630 to train the encoder. In another example, the UE optimizes the VQ codebook. In this example, the base station trains the decoder using the base station's reference encoder, generates the reference encoder input data set and the reference encoder output data set (the encoder data sets). The base station transmits the encoder data sets to the UE. The UE trains the encoder and uses the trained encoder to optimize the VQ codebook. The UE then transmits the optimized VQ codebook to the base station (shown in dotted line).

Quantization Aware VQ Codebook Optimization with Fixed VQ Codebook

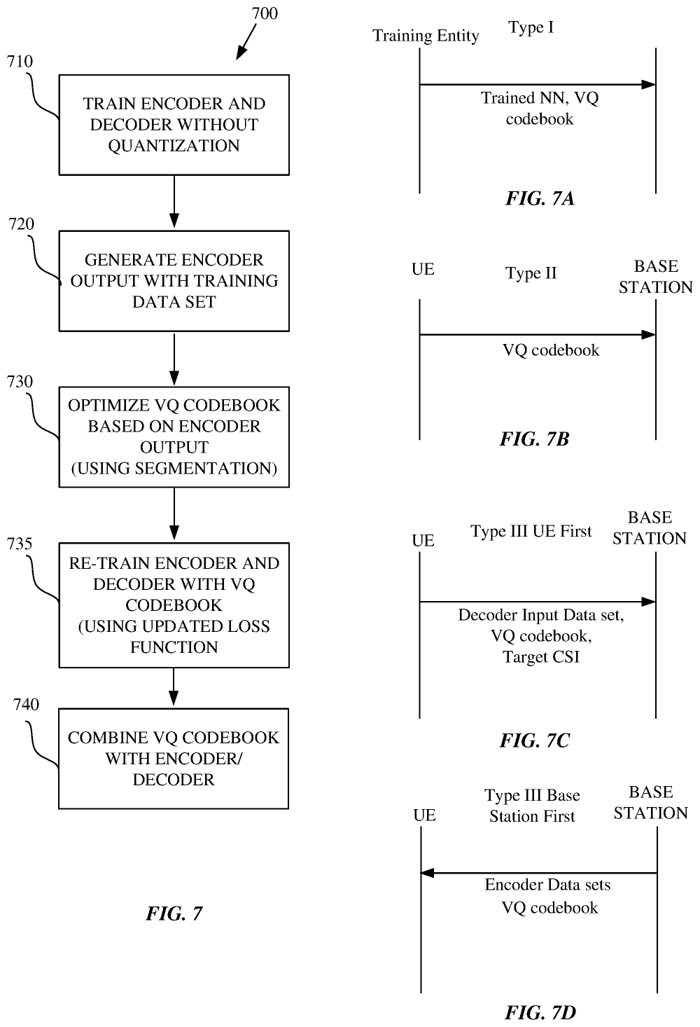

FIG. 7 is a flow diagram outlining an example method 700 for optimizing a VQ codebook in which the training of the encoder and decoder takes into account the quantization aspect. At 710, the encoder and decoder are trained without quantization using a training data set. This step may be facilitated by limiting the range of encoder output values for easier quantization. In one example, the encoder output is limited to a value between 0 and 1, which may be implemented by including a sigmod activation function as the last layer of the NN1 and NN2. At 720, inferencing is run on the training data set with the trained encoder to generate a VQ codebook training data set. At 730, the VQ codebook is optimized using the segment-based technique based on the VQ codebook training data set. For example, the VQ codebook may be optimized using Linde-Buzo-Gray (LBG) based algorithm or other appropriate algorithm.

At 735, the encoder and decoder are re-trained with the optimized VQ codebook in place. During the re-training process, a different loss function may be used as compared to the loss function used at 710, which optimizes the encoder NN weights and decoder NN weights in a manner to reduce auto-encoder loss and is quantization-aware. The loss function of 735 includes the loss function of 710 and also a loss function term that optimizes the encoder weight toward the codebook.

At 740, the optimized VQ codebook is combined with the encoder and decoder for end-to-end inferencing for CSI feedback compression. Combining the VQ codebook with the encoder and decoder includes transmitting the optimized VQ codebook to the non-optimizing entity using physical uplink shared channel (PUSCH) or physical downlink shared channel (PDSCH). As disclosed with reference to FIGS. 4 and 5, a segment-based VQ codebook will be a matrix having the dimension Mⁱⁿ, 2^{Mout}, where Mᵢₙ is the number of encoder output values per segment and Mₒᵤₜ is the number of VQ output bits per segment. FIG. 7A illustrates how operation 740 is performed during type I joint training (see FIG. 3A). The training entity (e.g., either UE or base station) performs steps 710-735 and then transmits the optimized VQ codebook along with the trained NN (e.g., a set of encoder or decoder weights) to the non-training entity. FIG. 7B illustrates how operation 740 is performed during type II joint training (see FIG. 3B). The encoder and decoder are trained jointly at 710, and then the UE performs steps 720-730 and transmits the optimized VQ codebook to the base station. The encoder and decoder are jointly re-trained at 735.

FIG. 7C illustrates how operations 730-740 are performed during type III separate training (see FIG. 3C). In type III training, when the UE trains first, at 730 the UE optimizes the VQ codebook using encoder outputs generated based on the training data set. The UE re-trains the encoder and reference decoder with the VQ codebook for quantization aware training at 735. At 740, the UE transmits the VQ codebook, the target CSI (optimal decoder outputs), and the re-trained encoder outputs (the decoder data set) to the base station. The base station trains the decoder using the decoder data set and using the VQ codebook.

FIG. 7D illustrates how operations 730-740 are performed during type III training when the base station trains first. The base station trains the decoder and the reference encoder using the training data set. The base station uses the trained reference encoder output to optimize the VQ codebook. The base station then retrains the decoder with the reference encoder and VQ codebook through quantization aware training at 735. The base station then transmits the reference encoder inputs and reference encoder outputs (encoder data sets) together with the VQ codebook to the UE for use in performing 710-730 to train the encoder in a quantization-aware manner.

### Joint Quantization Aware VQ Codebook Optimization

FIG. 8 is a flow diagram outlining an example method 800 for optimizing a VQ codebook in which the training of the encoder and is performed jointly with the optimization of the VQ codebook. At 810, the encoder, decoder are trained while the VQ codebook is optimized using the training data set. For example, the VQ codebook may be optimized using Linde-Buzo-Gray (LBG) based algorithm or other appropriate algorithm.

During the training process, a different loss function may be used as compared to the loss function used at 610 and 710, which optimizes the encoder NN weights and decoder NN weights in a manner to reduce auto-encoder loss and is quantization-unaware. The loss function of 810 includes the loss function of 610 and 710, a loss function term that optimizes the encoder weight toward the codebook, and a loss function term that optimizes the VQ codebook.

FIG. 8A illustrates how operation 810 is performed during type I joint training (see FIG. 3A). The training entity (e.g., either UE or base station) performs step 810 and then transmits the optimized VQ codebook along with the trained NN (e.g., a set of weights) to the non-training entity. FIG. 8B illustrates how operation 810 is performed during type II joint training (see FIG. 3B). The encoder, decoder, and VQ codebook are trained jointly at 810, and then the UE transmits the optimized VQ codebook to the base station using PUSCH.

FIG. 8C illustrates how operation 810 is performed during type Ill separate training (see FIG. 3C). In type III training, when the UE trains first, the UE trains the encoder and VQ codebook based on the training data set and then transmits the VQ codebook, target CSI (optimal decoder outputs), and the encoder outputs (the decoder input data set) to the base station.

FIG. 8D illustrates how operation 810 is performed during type III training when the base station trains first. The base station trains the decoder using the reference encoder and the training data set and then transmits the reference encoder inputs and reference encoder outputs (encoder data sets) to the UE for use in performing 810 to train the encoder and optimize the VQ codebook. The UE then transmits the optimized VQ codebook to the base station.

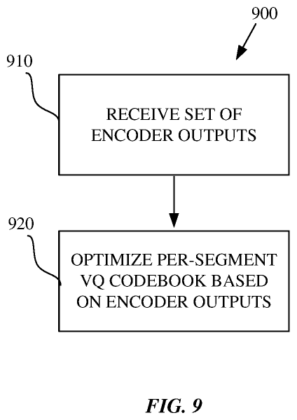

FIG. 9 is a flow diagram outlining an example segment-based method 900 for optimizing VQ codebook. The method 900 may be performed by a UE and/or a base station participating in one of the NN training and VQ optimization techniques outlined in FIGS. 3-8. The method includes, at 910, receiving a set of encoder outputs from an artificial intelligence (AI)-based encoder that generates compressed CSI feedback. The set of encoder outputs may be generated based on a trained AI-based encoder. At 920, the method includes optimizing a per-segment vector quantization (VQ) codebook for use in quantizing respective segments of encoder outputs based on the set of encoder outputs, wherein a segment comprises a subset of the set of encoder outputs. A number of inputs of the VQ codebook and a number of outputs of the VQ codebook are based on a number of bits configured for uplink channel information (UCI) and a number of segments in the set of encoder outputs. The method may include receiving configuration of the number of inputs of the VQ codebook, the number of output bits of the VQ codebook, or the number of segments. In one example, the method includes quantizing respective segments of subsequent AI-based encoder outputs based on the VQ codebook; and combining the quantized segments of the subsequent AI-based encoder outputs to generate the UCI.

In one example, the method includes de-quantizing respective segments of UCI encoding compressed CSI feedback based on the VQ codebook; combining the de-quantized segments of the UCI to generate estimated encoder output values; and decoding the estimated encoder output values to re-construct CSI feedback.

In one example, as shown in FIGS. 6A-6D, 7A-7D. 8A-8D, the method includes encoding the optimized VQ codebook for transmission to another network device using PUSCH or PDSCH. The method may include training an AI-based encoder neural network (NN) in the AI-based encoder based on a training data set; generating a decoder data set by inputting the training data set to the trained NN; encoding the decoder data set for transmission; and transmitting the VQ codebook and the decoder data set to a base station. The method may include training an AI-based decoder NN in the AI-based decoder based on a decoder data set; generating an encoder data set generated by the trained AI-based decoder NN; encoding the encoder data set for transmission; and transmitting the VQ codebook and the encoder data set to a UE.

In one example, the set of encoder outputs correspond to inference outputs of a trained AI-based encoder, and the method includes optimizing the VQ codebook using a Linde-Buzo-Gray (LBG) based algorithm. The method may include re-training the trained AI-based encoder, a trained AI-based decoder, or both, based on the optimized VQ codebook. The re-training may be performed using a loss function that includes a first loss term that optimizes the encoder weights toward the optimized VQ codebook.

In one example, the method includes training the AI-based encoder or the AI-based decoder using a loss function that includes a first loss term that optimizes the encoder weights toward the optimized VQ codebook and a second loss term that optimizes the VQ codebook.

### Scalar Quantization

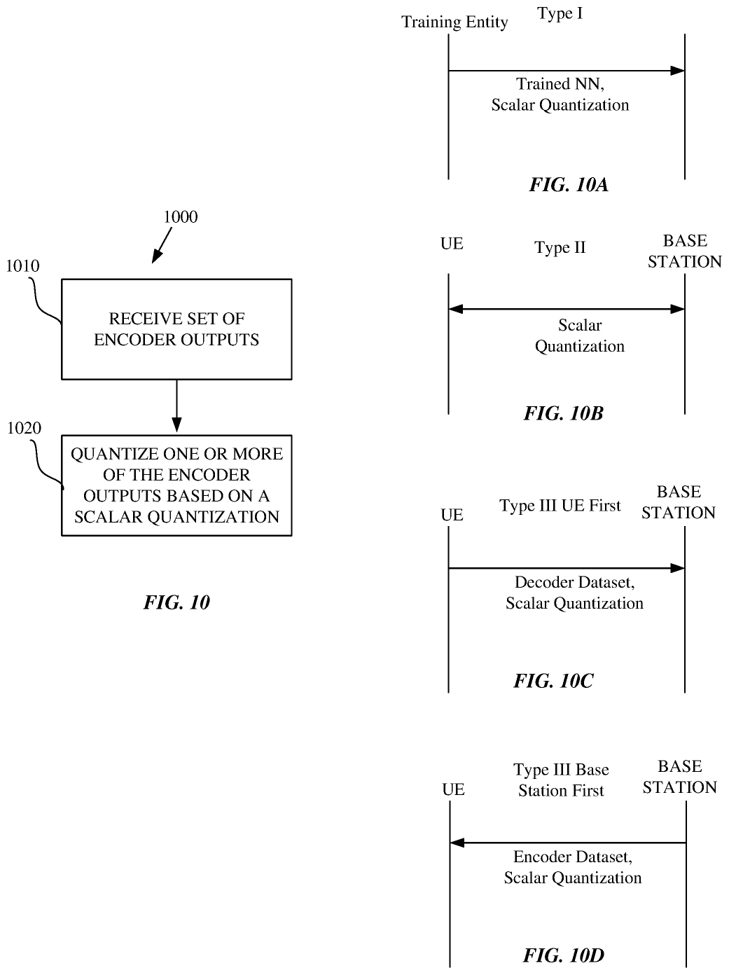

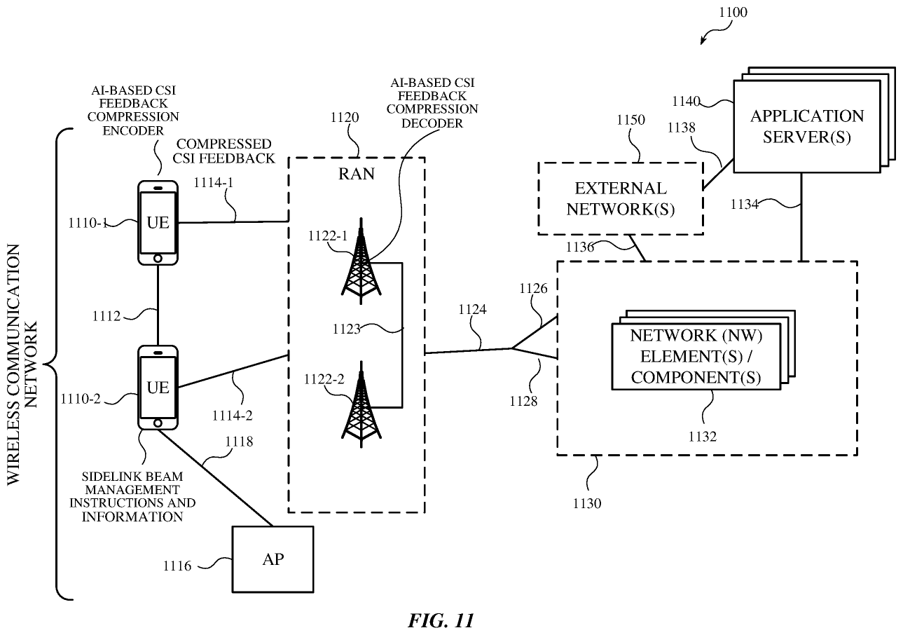

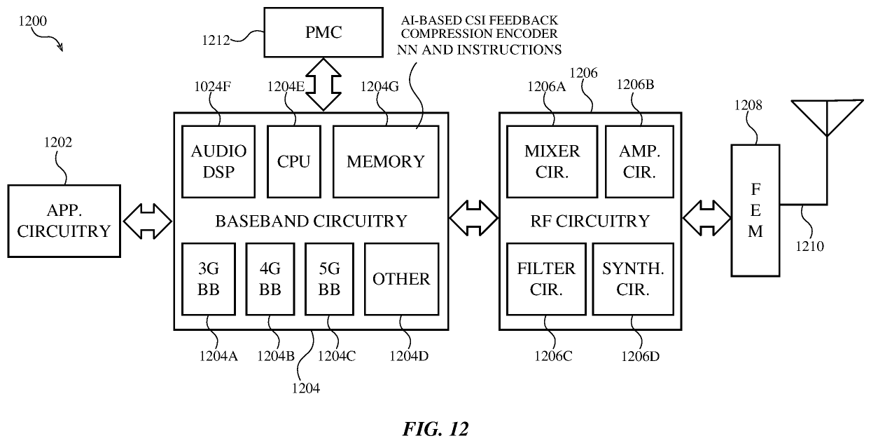

The quantizer circuitry and de-quantizer circuitry (see FIG. 1) may perform a scalar quantization rather than a vector quantization. As illustrated in FIG. 10, an example method 1000 for performing scalar quantization includes, at 1010, receiving a plurality of outputs from an artificial intelligence (AI) based encoder or AI-based decoder; and, at 1020 quantizing or de-quantizing one or more of the encoder outputs based on a scalar quantization.

The scalar quantization may be specified by a standard specification that defines a scalar quantization step, a start point, and an end point. For a uniform quantization, a step size may be defined. For a non-uniform quantization, specific scalar quantization values may be defined. The training of the encoder and decoder may be performed using the standard prescribed quantization. A configuration that includes indication of a selected one of several pre-configured scalar quantization methods may be performed.

The scalar quantization may not be standardized, in which case one of the training entities will optimize the scalar quantization based on trained encoder outputs. In one example, either the UE or base station is configured to optimize the scalar quantization based on output values from the AI-based encoder or AI-based decoder; and encode an indication of the scalar quantization for transmission to another network device using PUSCH or PDSCH.

FIG. 10A illustrates how the scalar quantization is transferred during type I joint training (see FIG. 3A). The training entity (e.g., either UE or base station) optimizes the scalar quantization and transmits the optimized scalar quantization along with the trained NN (e.g., a set of weights) to the non-training entity. As illustrated in FIG. 10B, during type II joint training (see FIG. 3B), the scalar quantization is aligned between the UE and base station prior to training.

FIG. 10C illustrates how the scalar quantization is transferred during type III separate training (see FIG. 3C). In type Ill training, when the UE trains first, the UE optimizes the scalar quantization using trained encoder outputs generated based on the training data set and then transmits the scalar quantization and the encoder outputs (the decoder data set) to the base station. FIG. 10D illustrates how the scalar quantization is transferred during type III training when the base station trains first. The base station trains the decoder and optimizes the scalar quantization using the reference encoder and the training data set and then transmits the trained decoder outputs (the encoder data set) and the scalar quantization to the UE.

Above are several flow diagrams outlining example methods and exchanges of messages. In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term encode when used with reference to some entity or value of an entity is to be construed broadly as encompassing any manner or technique for generating a data sequence or signal that communicates the entity to another component.

As used herein, the term select when used with reference to some entity or value of an entity is to be construed broadly as encompassing any manner of determining the entity or value of the entity from amongst a plurality or range of possible choices. For example, the term select is to be construed to encompass accessing and reading memory (e.g., lookup table, register, device memory, remote memory, and so on) that stores the entities or values for the entity and returning one entity or entity value from amongst those stored. The term select is to be construed as applying one or more constraints or rules to an input set of parameters to determine an appropriate entity or entity value. The term select is to be construed as broadly encompassing any manner of choosing an entity based on one or more parameters or conditions.

As used herein, the term derive when used with reference to some entity or value of an entity is to be construed broadly. “Derive” should be construed to encompass accessing and reading memory (e.g., lookup table, register, device memory, remote memory, and so on) that stores some initial value or foundational values and performing processing and/or logical/mathematical operations on the value or values to generate the derived entity or value for the entity. The term derive should be construed to encompass computing or calculating the entity or value of the entity based on other quantities or entities. The term derive should be construed to encompass any manner of deducing or identifying an entity or value of the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

FIG. 11 is an example network 1100 according to one or more implementations described herein. Example network 1100 may include UEs 1110-1, 1110-2, etc. (referred to collectively as “UEs 1110” and individually as “UE 1110”), a radio access network (RAN) 1120, a core network (CN) 1130, application servers 1140, and external networks 1150.

The systems and devices of example network 1100 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 1100 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 1110 may include smartphones (e.g., handheld touchscreen mobile computing devices connectable to one or more wireless communication networks). Additionally, or alternatively, UEs 1110 may include other types of mobile or non-mobile computing devices capable of wireless communications, such as personal data assistants (PDAs), pagers, laptop computers, desktop computers, wireless handsets, watches etc. In some implementations, UEs 1110 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 1110 may use one or more wireless channels 1112 to communicate with one another. As described herein, UE 1110-1 may communicate with Base station 1122 to request SL resources. Base station 1122 may respond to the request by providing UE 1110 with a dynamic grant (DG) or configured grant (CG) regarding SL resources. A DG may involve a grant based on a grant request from UE 1110. A CG may involve a resource grant without a grant request and may be based on a type of service being provided (e.g., services that have strict timing or latency requirements). UE 1110 may perform a clear channel assessment (CCA) procedure based on the DG or CG, select SL resources based on the CCA procedure and the DG or CG; and communicate with another UE 1110 based on the SL resources. The UE 1110 may communicate with Base station 1122 using a licensed frequency band and communicate with the other UE 1110 using an unlicensed frequency band.

UEs 1110 may communicate and establish a connection with (e.g., be communicatively coupled) with RAN 1120, which may involve one or more wireless channels 1114-1 and 1114-2, each of which may comprise a physical communications interface/layer.

As shown, UE 1110 may also, or alternatively, connect to access point (AP) 1116 via connection interface 1118, which may include an air interface enabling UE 1110 to communicatively couple with AP 1116. AP 1116 may comprise a wireless local area network (WLAN), WLAN node, WLAN termination point, etc. The connection 1118 may comprise a local wireless connection, such as a connection consistent with any IEEE 702.11 protocol, and AP 1116 may comprise a wireless fidelity (Wi-Fi®) router or other AP. While not explicitly depicted in FIG. 11, AP 1116 may be connected to another network (e.g., the Internet) without connecting to RAN 1120 or CN 1130.

RAN 1120 may include one or more RAN nodes 1122-1 and 1122-2 (referred to collectively as RAN nodes 1122, and individually as RAN node 1122) that enable channels 1114-1 and 1114-2 to be established between UEs 1110 and RAN 1120. RAN nodes 1122 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 1122 may include a roadside unit (RSU), a transmission reception point (TRxP or TRP), and one or more other types of ground stations (e.g., terrestrial access points). In some scenarios, RAN node 1122 may be a dedicated physical device, such as a macrocell base station, and/or a low power (LP) base station for providing femtocells, picocells or the like having smaller coverage areas, smaller user capacity, or higher bandwidth compared to macrocells.

The physical downlink shared channel (PDSCH) may carry user data and higher layer signaling to UEs 1110. The physical downlink control channel (PDCCH) may carry information about the transport format and resource allocations related to the PDSCH channel, among other things. The PDCCH may also inform UEs 1110 about the transport format, resource allocation, and hybrid automatic repeat request (HARQ) information related to the uplink shared channel. Typically, downlink scheduling (e.g., assigning control and shared channel resource blocks to UE 1110-2 within a cell) may be performed at any of the RAN nodes 1122 based on channel quality information fed back from any of UEs 1110. The downlink resource assignment information may be sent on the PDCCH used for (e.g., assigned to) each of UEs 1110.

As described with reference to FIGS. 1-10, any of the UEs 1110 may implement an AI-based CSI feedback encoder that cooperates with a paired AI-based CSI compression feedback decoder implemented by a RAN node 1122 to transmit the channel quality information in a compressed manner (e.g., compressed CSI feedback).

In some implementations, a downlink resource grid may be used for downlink transmissions from any of the RAN nodes 1122 to UEs 1110, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 1122 may be configured to wirelessly communicate with UEs 1110, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed spectrum may include the 5 GHz band. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

The RAN nodes 1122 may be configured to communicate with one another via interface 1123. In implementations where the system is an LTE system, interface 1123 may be an X2 interface. In NR systems, interface 1123 may be an Xn interface. The X2 interface may be defined between two or more RAN nodes 1122 (e.g., two or more eNBs/gNBs or a combination thereof) that connect to evolved packet core (EPC) or CN 1130, or between two eNBs connecting to an EPC.

As shown, RAN 1120 may be connected (e.g., communicatively coupled) to CN 1130. CN 1130 may comprise a plurality of network elements 1132, which are configured to offer various data and telecommunications services to customers/subscribers (e.g., users of UEs 1110) who are connected to the CN 1130 via the RAN 1120. In some implementations, CN 1130 may include an evolved packet core (EPC), a 5G CN, and/or one or more additional or alternative types of CNs. The components of the CN 1130 may be implemented in one physical node or separate physical nodes including components to read and execute instructions from a machine-readable or computer-readable medium (e.g., a non-transitory machine-readable storage medium

FIG. 12 is a diagram of an example of components of a network device according to one or more implementations described herein. In some implementations, the device 1200 can include application circuitry 1202, baseband circuitry 1204, RF circuitry 1206, front-end module (FEM) circuitry 1208, one or more antennas 1210, and power management circuitry (PMC) 1212 coupled together at least as shown. The components of the illustrated device 1200 can be included in a UE or a RAN node. In some implementations, the device 1200 can include fewer elements (e.g., a RAN node may not utilize application circuitry 1202, and instead include a processor/controller to process IP data received from a CN or an Evolved Packet Core (EPC)). In some implementations, the device 1200 can include additional elements such as, for example, memory/storage, display, camera, sensor (including one or more temperature sensors, such as a single temperature sensor, a plurality of temperature sensors at different locations in device 1200, etc.), or input/output (I/O) interface. In other implementations, the components described below can be included in more than one device (e.g., said circuitries can be separately included in more than one device for Cloud-RAN (C-RAN) implementations).

The application circuitry 1202 can include one or more application processors. For example, the application circuitry 1202 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1200. In some implementations, processors of application circuitry 1202 can process IP data packets received from an EPC.

The baseband circuitry 1204 can include circuitry such as, but not limited to, one or more single-core or multi-core processors. The baseband circuitry 1204 can include one or more baseband processors or control logic to process baseband signals received from a receive signal path of the RF circuitry 1206 and to generate baseband signals for a transmit signal path of the RF circuitry 1206. Baseband circuitry 1204 can interface with the application circuitry 1202 for generation and processing of the baseband signals and for controlling operations of the RF circuitry 1206. For example, in some implementations, the baseband circuitry 1204 can include a 3G baseband processor 1204A, a 4G baseband processor 1204B, a 5G baseband processor 1204C, or other baseband processor(s) 1204D for other existing generations, generations in development or to be developed in the future (e.g., 5G, 6G, etc.).

The baseband circuitry 1204 (e.g., one or more of baseband processors 1204A-D) can handle various radio control functions that enable communication with one or more radio networks via the RF circuitry 1206. In other implementations, some or all of the functionality of baseband processors 1204A-D can be included in modules stored in the memory 1204G and executed via a Central Processing Unit (CPU) 1204E. In some implementations, the baseband circuitry 1204 can include one or more audio digital signal processor(s) (DSP) 1204F.

In some implementations, memory 1204G may receive and/or store instructions for implementing and a neural network associated with an AI-based CSI feedback encoder that cooperates with a paired AI-based CSI compression feedback decoder implemented by a RAN node to generate compressed CSI feedback as described with reference to FIGS. 1-10.

RF circuitry 1206 can enable communication with wireless networks using modulated electromagnetic radiation through a non-solid medium. In various implementations, the RF circuitry 1206 can include switches, filters, amplifiers, etc. to facilitate the communication with the wireless network. RF circuitry 1206 can include a receive signal path which can include circuitry to down-convert RF signals received from the FEM circuitry 1208 and provide baseband signals to the baseband circuitry 1204. RF circuitry 1206 can also include a transmit signal path which can include circuitry to up-convert baseband signals provided by the baseband circuitry 1204 and provide RF output signals to the FEM circuitry 1208 for transmission.

In some implementations, the receive signal path of the RF circuitry 1206 can include mixer circuitry 1206A, amplifier circuitry 1206B and filter circuitry 1206C. In some implementations, the transmit signal path of the RF circuitry 1206 can include filter circuitry 1206C and mixer circuitry 1206A. RF circuitry 1206 can also include synthesizer circuitry 1206D for synthesizing a frequency for use by the mixer circuitry 1206A of the receive signal path and the transmit signal path.

Examples herein can include subject matter such as a method, means for performing acts or blocks of the method, at least one machine-readable medium including executable instructions that, when performed by a machine or circuitry (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the disclosure herein. Also, one or more of the acts depicted herein may be carried out in one or more separate acts and/or phases. In some embodiments, the methods illustrated above may be implemented in a computer readable medium using instructions stored in a memory. Many other embodiments and variations are possible within the scope of the claimed disclosure.

The term “couple” is used throughout the specification. The term may cover connections, communications, or signal paths that enable a functional relationship consistent with the description of the present disclosure. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A baseband processor configured to, when executing instructions stored in a memory, perform operations comprising:
receiving a set of encoder outputs from an artificial intelligence (AI)-based encoder that generates compressed CSI feedback; and
based on the set of encoder outputs, optimizing a per-segment vector quantization (VQ) codebook for use in quantizing respective segments of encoder outputs, wherein each segment of encoder outputs comprises a subset of the set of encoder outputs, wherein a number of inputs of the VQ codebook and a number of outputs of the VQ codebook are based on a number of bits configured for uplink channel information (UCI) and a number of segments in the set of encoder outputs.

2. The baseband processor of claim 1, wherein the operations comprise receiving configuration of the number of inputs of the VQ codebook, the number of output bits of the VQ codebook, or the number of segments.

3. The baseband processor of claim 1, wherein the operations comprise
quantizing respective segments of subsequent AI-based encoder outputs based on the VQ codebook; and
combining the quantized segments of the subsequent AI-based encoder outputs to generate the UCI.

4. The baseband processor of claim 1, wherein the operations comprise
de-quantizing respective segments of UCI encoding compressed CSI feedback based on the VQ codebook;
combining the de-quantized segments of the UCI to generate estimated encoder output values; and
decoding the estimated encoder output values to re-construct CSI feedback.

5. The baseband processor of claim 1, wherein the set of encoder outputs correspond to inference outputs of a trained AI-based encoder, wherein the processor is configured to optimize the VQ codebook using a Linde-Buzo-Gray (LBG) based algorithm.

6. The baseband processor of claim 1, wherein the operations comprise re-training a trained AI-based encoder, a trained AI-based decoder, or both, based on the optimized VQ codebook.

7. The baseband processor of claim 6, wherein the operations comprise re-training the trained AI-based encoder or the trained AI-based decoder using a loss function that includes a first loss term that optimizes encoder weights toward the optimized VQ codebook.

8. The baseband processor of claim 1, wherein the operations comprise optimizing the per-segment VQ codebook based on the encoder outputs of the AI-based encoder generated during training of the AI-based encoder.

9. The baseband processor of claim 8, wherein the operations comprise training the AI-based encoder or an AI-based decoder using a loss function that includes a first loss term that optimizes encoder weights toward the optimized VQ codebook and a second loss term that optimizes the VQ codebook.

10. A network device, comprising
a memory; and
a baseband processor configured to cause the network device to
receive a plurality of encoder outputs from an artificial intelligence (AI) based encoder; and
quantizing or de-quantizing one or more of the encoder outputs based on a scalar quantization.

11. The network device of claim 10, wherein the baseband processor is configured to cause the network device to
receive configuration of a range of output values for the AI-based encoder, a uniform step size, a non-uniform quantization values, a start point, or an end point of the scalar quantization.

12. The network device of claim 10, wherein the baseband processor is configured to cause the network device to
optimize the scalar quantization based on inference results of a trained AI-based encoder; and
encode an indication of the scalar quantization for transmission to another network device using a physical uplink shared channel (PUSCH) or a physical downlink shared channel (PDSCH).

13. The network device of claim 12, wherein the baseband processor is configured to cause the network device to transmit the indication of the scalar quantization and a set of weight values for the AI-based encoder or an AI-based decoder.

14. The network device of claim 12, wherein the baseband processor is configured to cause the network device to transmit the indication of the scalar quantization and a data set for use in training the other of the AI-based encoder or an AI-based decoder.

15. The network device of claim 10, wherein the network device comprises a user equipment (UE).

16. The network device of claim 10, wherein the network device comprises a base station.

17. A network device, comprising:
a memory; and
a baseband processor coupled to the memory, the processor configured to, when executing instructions stored in the memory, cause the network device to:
receive a set of encoder outputs from an artificial intelligence (AI)-based encoder that generates compressed CSI feedback;
based on the set of encoder outputs, optimize a per-segment vector quantization (VQ) codebook for use in quantizing respective segments of encoder outputs, wherein each segment of encoder outputs comprises a subset of the set of encoder outputs, wherein a number of inputs of the VQ codebook and a number of outputs of the VQ codebook are based on a number of bits configured for uplink channel information (UCI) and a number of segments in the set of encoder outputs; and
encode the optimized VQ codebook for transmission to another network device using a physical uplink shared channel (PUSCH) or a physical downlink shared channel (PDSCH).

18. The network device of claim 17, wherein the baseband processor is configured to cause the network device to receive configuration of the number of inputs of the VQ codebook, the number of output bits of the VQ codebook, or the number of segments.

19. The network device of claim 17, wherein the baseband processor is configured to cause the network device to
train an AI-based encoder neural network (NN) in the AI-based encoder based on a training data set;
generate a decoder data set by inputting the training data set to the trained NN;
encode the decoder data set for transmission; and
cause transmission of the VQ codebook and the decoder data set to a base station.

20. The network device of claim 17, wherein the baseband processor is configured to cause the network device to
train an AI-based decoder NN in the AI-based decoder based on a decoder data set;
generate an encoder data set generated by the trained AI-based decoder NN;
encode the encoder data set for transmission; and
cause transmission of the VQ codebook and the encoder data set to a UE.
